(19) United States
(12) Patent Application Publication
(10) Pub. No.: US 2018/0268363 A1
(43) Pub. Date: Sep. 20, 2018

(54) Single Job Backorder Processing Using Prioritized Requirements

(71) Applicant: SAP SE, Walldorf (DE)

(72) Inventors: Volker Jaeck, Nußloch (DE); Wolfram Schick, Karlsruhe (DE); Stefan Siebert, Hockenheim (DE); Rolf Mantel, Heidelberg (DE); Jibi Joseph Vadakayil, Walldorf (DE)

(21) Appl. No.: 15/463,561

(22) Filed: Mar. 20, 2017

(51) Int. Cl. G06Q 10/08; G06Q 10/06

(52) U.S. Cl. CPC G06Q 10/0875; G06Q 30/0635; G06Q 10/06315

(57) ABSTRACT

Systems and methods are provided herein for a single job backorder processing using prioritized requirements. Data comprising a plurality of requirements associated with an availability check is received. Each requirement comprises a confirmation strategy including a check prioritizer. The plurality of requirements are sorted in a hierarchical order based on the check prioritizer and the confirmation strategy. A cluster is determined based on the sorted plurality of requirements. The cluster is iteratively evaluated with availability data stored in a remote data store to determine availability of the cluster. Result analytics corresponding to the availability of the cluster are provided.

### TECHNICAL FIELD

The subject matter described herein relates to single job backorder processing using prioritized requirements.

### BACKGROUND

Backorder processing (BOP) is a logistic-related process that involves numerous calculations for Available-to-Promise (ATP) confirmations. In complex business scenarios, backorder processing is split into either several jobs or a sequence of batch jobs without a direct linkage between the jobs. The execution of unlinked jobs, can cause result interference and/or scattered results that can limit transactional protection.

### SUMMARY

In one aspect, data comprising a plurality of requirements associated with an availability check is received. Each requirement comprises a confirmation strategy including a check prioritizer. The plurality of requirements is sorted in a hierarchical order based on a check prioritizer and the confirmation strategy. A cluster is determined based on the sorted plurality of requirements. The cluster is iteratively evaluated with availability data stored in a remote data store to determine availability of the cluster. Result analytics corresponding to the availability of the cluster are provided.

In some variations, iteratively evaluating the cluster includes determining a success or a failure of the plurality of requirements within the cluster. The failure of at least one requirement can be resolved by either excluding the at least one requirement from the cluster or initiating display of the failure in a user alert on a graphical user interface. Resolving the failure can include at least one of modifying the check prioritizer of the at least one requirement, excluding the at least one requirement, adding new requirements to the plurality of requirements, modifying geographical aspects of the at least one requirement, modifying time-dependent aspects of the at least one requirement, and initiating display of the failure in a user alert on a graphical user interface.

The plurality of requirements includes at least one of a win requirement, a gain requirement, a redistribute requirement, a fill requirement, or a lose requirement. The hierarchical order of the check prioritizer from a highest check prioritizer to a lowest check prioritizer can include the win requirement, the gain requirement, the redistribute requirement, or the fill requirement.

In some aspects, systems can be provided for implementing various operations described herein that include at least one data processor and memory. In some variations, the system can include an in-memory database. In other aspects, computer-programmable products can be provided for implementing various operations described herein.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides an ability to perform backorder processing using a single requirement group instead of multiple requirement groups enabling more simplified processing. Simplified processing can result in simplified system maintenance. Additionally, the subject matter described herein provides for automatic resolution of failed requirements.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating an example database system for use in connection with the current subject matter;

FIG. 2 is a system diagram illustrating a distributed database system having a plurality of database instances;

FIG. 3 is a system diagram of an index server forming part of the database system of FIG. 1;

FIG. 4A is an example process flow chart for various requirement types;

FIG. 4B is an process flow diagram displaying the relationship inheritance of each requirement;

FIG. 5 is an example process interaction diagram illustrating interaction between a BOP run variant, confirmation strategies, and filters;

FIG. 6 is an example process flow diagram of a failed BOP run;

FIG. 7 is an example process flow diagram of backorder processing;

FIG. 8 is a data flow diagram of backorder processing;

FIG. 9 is an example process flow diagram for single job backorder processing using prioritized requirements; and

FIG. 10 is a diagram illustrating a sample computing device architecture for implementing various aspects described herein.

Like reference symbols in the various drawings indicate like elements.

### DETAILED DESCRIPTION

The use of a single job for backorder processing can allow for a simplified setup. With the single job, the evaluation of numerous ATP checks can be automated and provide for enhanced selection of additional order items or reclassification of order items. Within a single job, requirements are processed with different confirmation strategies including a win strategy, gain strategy, redistribute strategy, a fill strategy, and a lose strategy to fulfill a requirement.

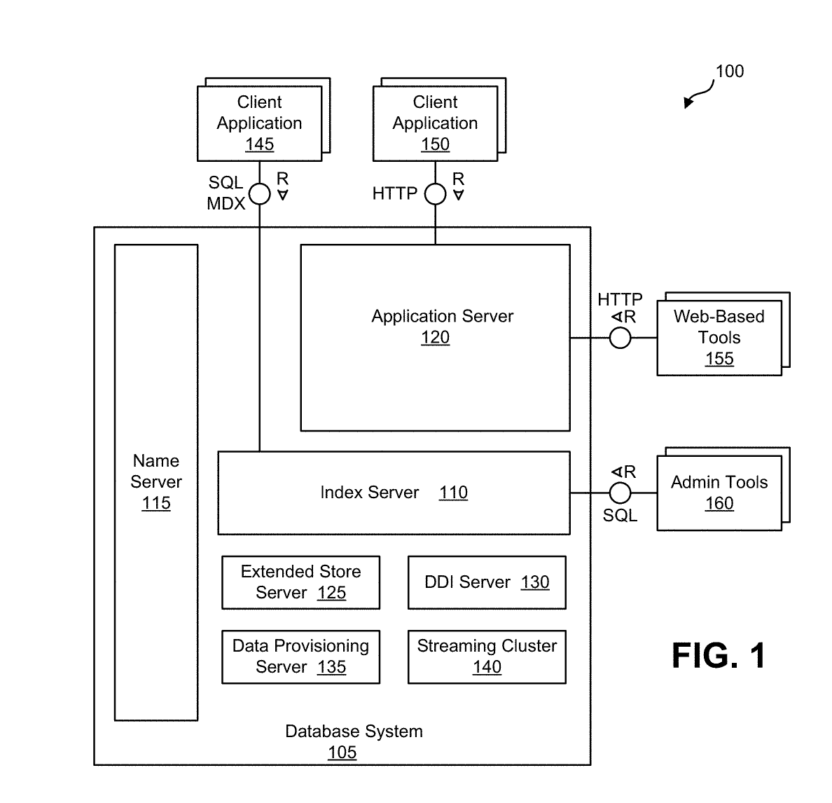

FIG. 1 is a diagram 100 illustrating a database system 105 that can be used to implement aspects of the current subject matter. The database system 105 can, for example, be an in-memory database in which all relevant data is kept in main memory so that read operations can be executed without disk input output (I/O) and in which disk storage is required to make any changes durables. The database system 105 can include a plurality of servers including, for example, one or more of an index server 110, a name server 115, and/or an application server 120. The database system 105 can also include one or more of an extended store server 125, a database deployment infrastructure (DDI) server 130, a data provisioning server 135, and/or a streaming cluster 140. The database system 105 can be accessed by a plurality of remote clients 145, 150 via different protocols such as SQL/MDX (by way of the index server 110) and/or web-based protocols such as HTTP (by way of the application server 120).

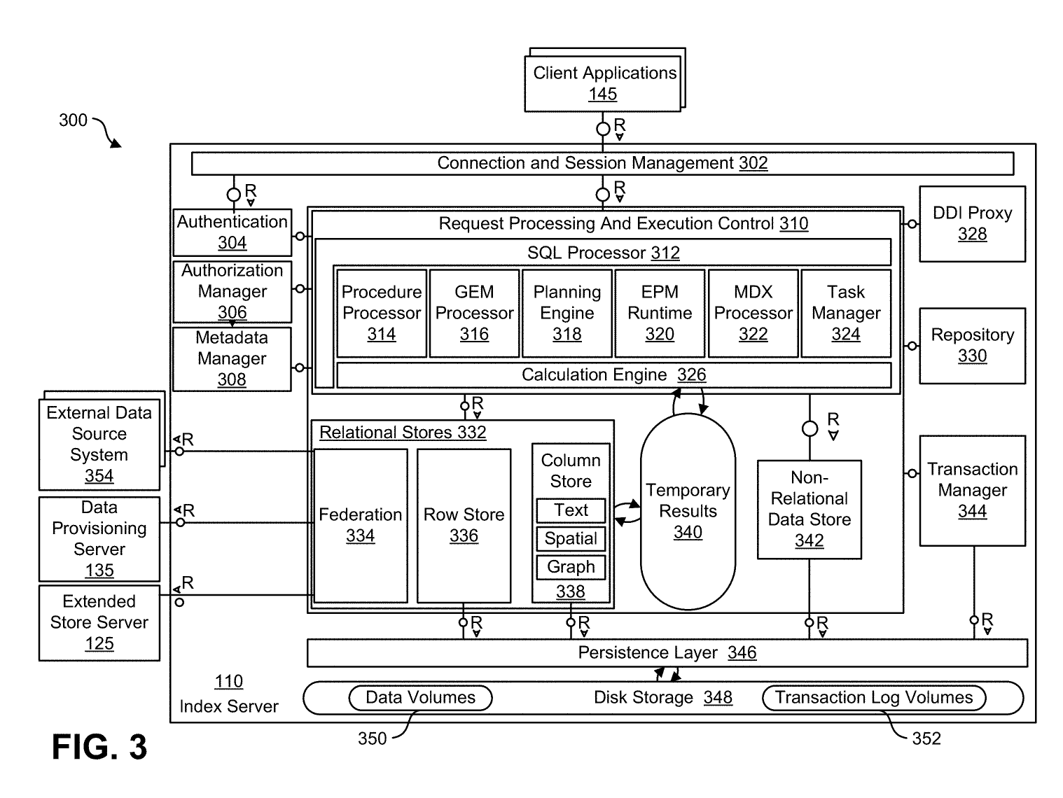

The index server 110 can contain in-memory data stores and engines for processing data. The index server 110 can also be accessed by remote tools (via, for example, SQL queries), that can provide various development environment and administration tools. Additional details regarding an example implementation of the index server 110 is described and illustrated in connection with diagram 300 of FIG. 3.

The name server 115 can own information about the topology of the database system 105. In a distributed database system, the name server 115 can know where various components are running and which data is located on which server. In a database system 105 with multiple database containers, the name server 115 can have information about existing database containers and it can also host the system database. For example, the name server 115 can manage the information about existing tenant databases. Unlike a name server 115 in a single-container system, the name server 115 in a database system 105 having multiple database containers does not store topology information such as the location of tables in a distributed database. In a multi-container database system 105 such database-level topology information can be stored as part of the catalogs of the tenant databases.

The application server 120 can enable native web applications used by one or more remote clients 150 accessing the database system 105 via a web protocol such as HTTP. The application server 120 can allow developers to write and run various database applications without the need to run an additional application server. The application server 120 can also used to run web-based tools 155 for administration, life-cycle management, and development. Other administration and development tools 160 can directly access the index server 110 for, example, via SQL and other protocols.

The extended store server 125 can be part of a dynamic tiering option that can include a high-performance disk-based column store for very big data up to the petabyte range and beyond. Less frequently accessed data (for which is it non-optimal to maintain in main memory of the index server 110) can be put into the extended store server 125. The dynamic tiering of the extended store server 125 allows for hosting of very large databases with a reduced cost of ownership as compared to conventional arrangements.

The DDI server 130 can be a separate server process that is part of a database deployment infrastructure (DDI). The DDI can be a layer of the database system 105 that simplifies the deployment of database objects using declarative design time artifacts. DDI can ensure a consistent deployment, for example by guaranteeing that multiple objects are deployed in the right sequence based on dependencies, and by implementing a transactional all-or-nothing deployment.

The data provisioning server 135 can provide enterprise information management and enable capabilities such as data provisioning in real time and batch mode, real-time data transformations, data quality functions, adapters for various types of remote sources, and an adapter SDK for developing additional adapters.

The streaming cluster 140 allows for various types of data streams (i.e., data feeds, etc.) to be utilized by the database system 105. The streaming cluster 140 allows for both consumption of data streams and for complex event processing.

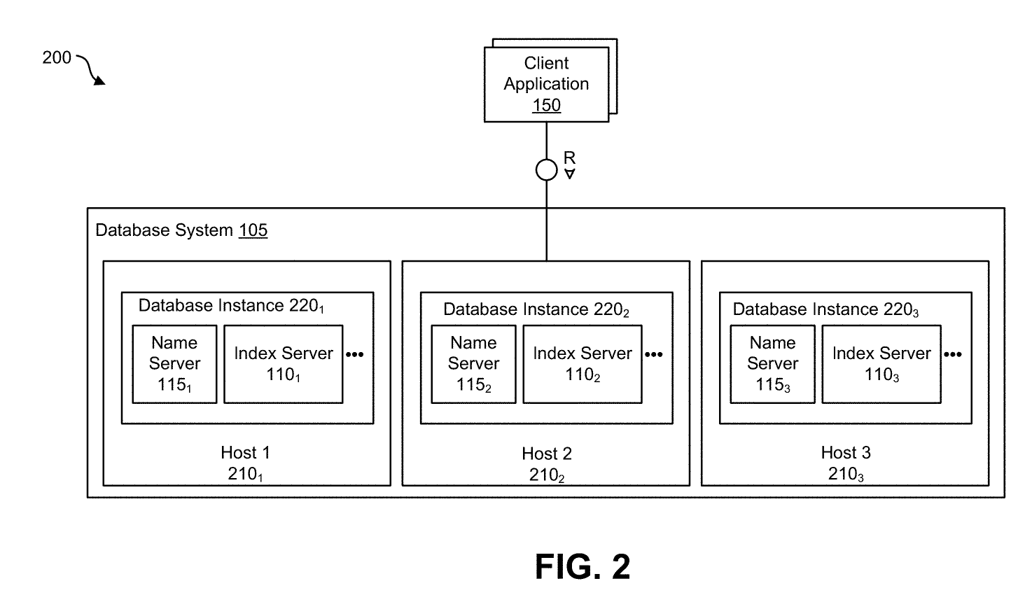

FIG. 2 is a diagram 200 illustrating a variation of the database system 105 that can support distribution of server components across multiple hosts for scalability and/or availability purposes. This database system 105 can, for example, be identified by a single system ID (SID) and it is perceived as one unit from the perspective of an administrator, who can install, update, start up, shut down, or backup the system as a whole. The different components of the database system 105 can share the same metadata, and requests from client applications 230 can be transparently dispatched to different servers 1101-3, 1201-3, in the system, if required.

As is illustrated in FIG. 2, the distributed database system 105 can be installed on more than one host 2101-3. Each host 2101-3 is a machine that can comprise at least one data processor (e.g., a CPU, etc.), memory, storage, a network interface, and an operation system and which executes part of the database system 105. Each host 2101-3 can execute a database instance 2201-3 which comprises the set of components of the distributed database system 105 that are installed on one host 2101-3. FIG. 2 shows a distributed system with three hosts, which each run a name server 1101-3, index server 1201-3, and so on (other components are omitted to simplify the illustration).

FIG. 3 is a diagram 300 illustrating an architecture for the index server 110 (which can, as indicated above, be one of many instances). A connection and session management component 302 can create and manage sessions and connections for the client applications 145. For each session, a set of parameters can be maintained such as, for example, auto commit settings or the current transaction isolation level.

Requests from the client applications 145 can be processed and executed by way of a request processing and execution control component 310. The database system 105 offers rich programming capabilities for running application-specific calculations inside the database system. In addition to SQL, MDX, and WIPE, the database system 105 can provide different programming languages for different use cases. SQLScript can be used to write database procedures and user defined functions that can be used in SQL statements. The L language is an imperative language, which can be used to implement operator logic that can be called by SQLScript procedures and for writing user-defined functions.

Once a session is established, client applications 145 typically use SQL statements to communicate with the index server 110 which can be handled by a SQL processor 312 within the request processing and execution control component 310. Analytical applications can use the multidimensional query language MDX (MultiDimensional eXpressions) via an MDX processor 322. For graph data, applications can use GEM (Graph Query and Manipulation) via a GEM processor 316, a graph query and manipulation language. SQL statements and MDX queries can be sent over the same connection with the client application 145 using the same network communication protocol. GEM statements can be sent using a built-in SQL system procedure.

The index server 110 can include an authentication component 304 that can be invoked with a new connection with a client application 145 is established. Users can be authenticated either by the database system 105 itself (login with user and password) or authentication can be delegated to an external authentication provider. An authorization manager 306 can be invoked by other components of the database system 145 to check whether the user has the required privileges to execute the requested operations.

Each statement can be processed in the context of a transaction. New sessions can be implicitly assigned to a new transaction. The index server 110 can include a transaction manager 344 that coordinates transactions, controls transactional isolation, and keeps track of running and closed transactions. When a transaction is committed or rolled back, the transaction manager 344 can inform the involved engines about this event so they can execute necessary actions. The transaction manager 344 can provide various types of concurrency control and it can cooperate with a persistence layer 346 to achieve atomic and durable transactions.

Incoming SQL requests from the client applications 145 can be received by the SQL processor 312. Data manipulation statements can be executed by the SQL processor 312 itself. Other types of requests can be delegated to the respective components. Data definition statements can be dispatched to a metadata manager 306, transaction control statements can be forwarded to the transaction manager 344, planning commands can be routed to a planning engine 318, and task related commands can forwarded to a task manager 324 (which can be part of a larger task framework). Incoming MDX requests can be delegated to the MDX processor 322. Procedure calls can be forwarded to the procedure processor 314, which further dispatches the calls, for example to a calculation engine 326, the GEM processor 316, a repository 300, or a DDI proxy 328.

The index server 110 can also include a planning engine 318 that allows planning applications, for instance for financial planning, to execute basic planning operations in the database layer. One such basic operation is to create a new version of a data set as a copy of an existing one while applying filters and transformations. For example, planning data for a new year can be created as a copy of the data from the previous year. Another example for a planning operation is the disaggregation operation that distributes target values from higher to lower aggregation levels based on a distribution function.

The SQL processor 312 can include an enterprise performance management (EPM) runtime component 320 that can form part of a larger platform providing an infrastructure for developing and running enterprise performance management applications on the database system 105. While the planning engine 318 can provide basic planning operations, the EPM platform provides a foundation for complete planning applications, based on by application-specific planning models managed in the database system 105.

The calculation engine 326 can provide a common infrastructure that implements various features such as SQLScript, MDX, GEM, tasks, and planning operations. The SQLScript processor 312, the MDX processor 322, the planning engine 318, the task manager 324, and the GEM processor 316 can translate the different programming languages, query languages, and models into a common representation that is optimized and executed by the calculation engine 326. The calculation engine 326 can implement those features using temporary results 340 which can be based, in part, on data within the relational stores 332.

Metadata can be accessed via the metadata manager component 308. Metadata, in this context, can comprise a variety of objects, such as definitions of relational tables, columns, views, indexes and procedures. Metadata of all these types can be stored in one common database catalog for all stores. The database catalog can be stored in tables in a row store 336 forming part of a group of relational stores 332. Other aspects of the database system 105 including, for example, support and multi-version concurrency control can also be used for metadata management. In distributed systems, central metadata is shared across servers and the metadata manager 308 can coordinate or otherwise manage such sharing.

The relational stores 332 form the different data management components of the index server 110 and these relational stores can, for example, store data in main memory. The row store 336, a column store 338, and a federation component 334 are all relational data stores which can provide access to data organized in relational tables. The column store 338 can store relational tables column-wise (i.e., in a column-oriented fashion, etc.). The column store 338 can also comprise text search and analysis capabilities, support for spatial data, and operators and storage for graph-structured data. With regard to graph-structured data, from an application viewpoint, the column store 338 could be viewed as a non-relational and schema-flexible in-memory data store for graph-structured data. However, technically such a graph store is not a separate physical data store. Instead, it is built using the column store 338, which can have a dedicated graph API.

The row store 336 can store relational tables row-wise. When a table is created, the creator can specify whether it should be row or column-based. Tables can be migrated between the two storage formats. While certain SQL extensions are only available for one kind of table (such as the “merge” command for column tables), standard SQL can be used on all tables. The index server 110 also provides functionality to combine both kinds of tables in one statement (join, sub query, union).

The federation component 334 can be viewed as a virtual relational data store. The federation component 334 can provide access to remote data in external data source system(s) 354 through virtual tables, which can be used in SQL queries in a fashion similar to normal tables.

The database system 105 can include an integration of a non-relational data store 342 into the index server 110. For example, the non-relational data store 342 can have data represented as networks of C++ objects, which can be persisted to disk. The non-relational data store 342 can be used, for example, for optimization and planning tasks that operate on large networks of data objects, for example in supply chain management. Unlike the row store 336 and the column store 338, the non-relational data store 342 does not use relational tables; rather, objects can be directly stored in containers provided by the persistence layer 346. Fixed size entry containers can be used to store objects of one class. Persisted objects can be loaded via their persisted object IDs, which can also be used to persist references between objects. In addition, access via in-memory indexes is supported. In that case, the objects need to contain search keys. The in-memory search index is created on first access. The non-relational data store 342 can be integrated with the transaction manager 344 to extends transaction management with sub-transactions, and to also provide a different locking protocol and implementation of multi version concurrency control.

An extended store is another relational store that can be used or otherwise form part of the database system 105. The extended store can, for example, be a disk-based column store optimized for managing very big tables, which ones do not want to keep in memory (as with the relational stores 332). The extended store can run in an extended store server 125 separate from the index server 110. The index server 110 can use the federation component 334 to send SQL statements to the extended store server 125.

The persistence layer 346 is responsible for durability and atomicity of transactions. The persistence layer 346 can ensure that the database system 105 is restored to the most recent committed state after a restart and that transactions are either completely executed or completely undone. To achieve this goal in an efficient way, the persistence layer 346 can use a combination of write-ahead logs, shadow paging and savepoints. The persistence layer 346 can provide interfaces for writing and reading persisted data and it can also contain a logger component that manages a transaction log. Transaction log entries can be written explicitly by using a log interface or implicitly when using the virtual file abstraction.

The persistence layer 236 stores data in persistent disk storage 348 which, in turn, can include data volumes 350 and/or transaction log volumes 352 that can be organized in pages. Different page sizes can be supported, for example, between 4 k and 16 M. Data can be loaded from the disk storage 348 and stored to disk page wise. For read and write access, pages can be loaded into a page buffer in memory. The page buffer need not have a minimum or maximum size, rather, all free memory not used for other things can be used for the page buffer. If the memory is needed elsewhere, least recently used pages can be removed from the cache. If a modified page is chosen to be removed, the page first needs to be persisted to disk storage 348. While the pages and the page buffer are managed by the persistence layer 346, the in-memory stores (i.e., the relational stores 332) can access data within loaded pages.

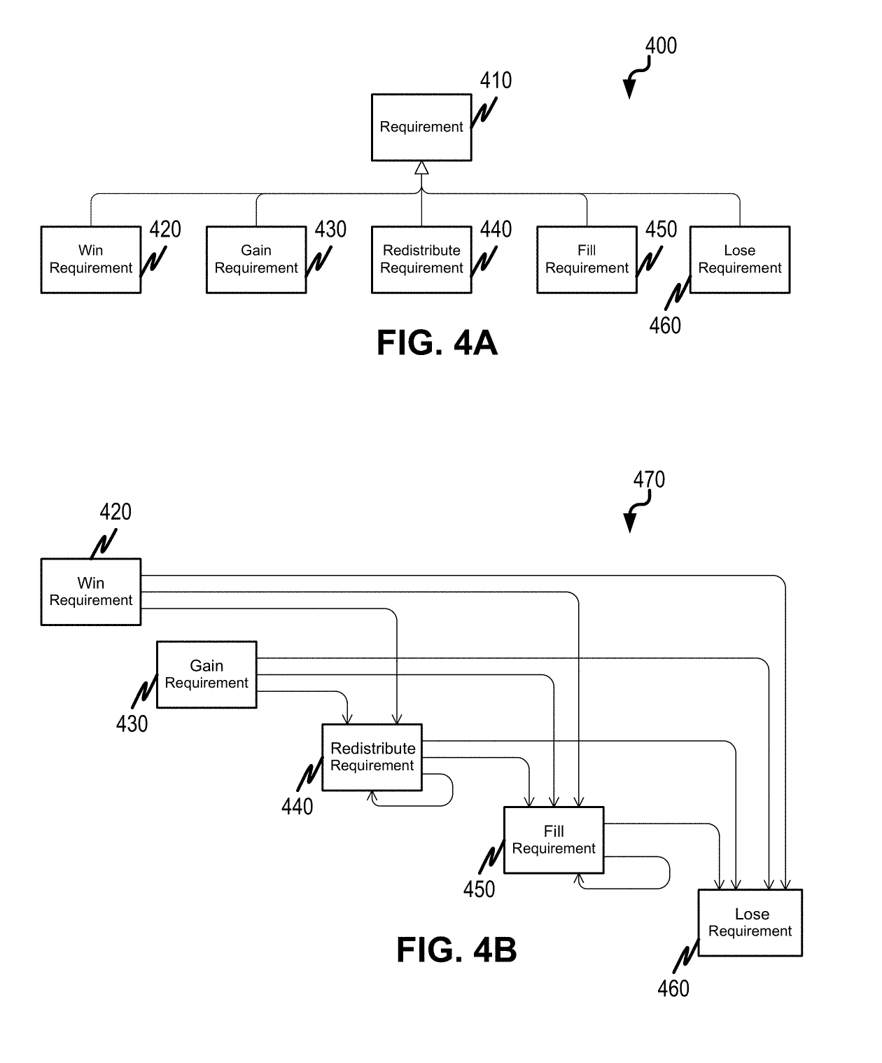

FIG. 4A is an example process flow chart 400 for various requirement types. Each requirement 410 can be either a win requirement 420, a gain requirement 430, a redistribute requirement 440, a fill requirement 450, or a lose requirement 460. Each requirement can have a check prioritizer that identifies a priority associated with a specific requirement. In order of hierarchy starting with the highest priority, a check prioritizer can prioritize each requirement 410 amongst a win requirement 420, a gain requirement 430, a redistribute requirement 440, and a fill requirement 450. In other words, a win requirement 420 has a higher check prioritizer than a gain requirement 430. Lose requirement 460, however, does not have an assigned check prioritizer as lose requirement 460 loses its confirmation in order to enable other requirements to be confirmed.

A win requirement 420 is confirmed as requested in quantity and confirmed in time. A gain requirement 430 is improved, if possible, and keeps at least the same confirmation as before the BOP run. Win requirement 420 and gain requirement 430 are fulfilled as described herein. When win requirement 420 and/or gain requirement 430 cannot be fulfilled during a BOP run, execution of the BOP run can be stopped and exceptions can be handled. For example, the exception handling can include an interactive BOP prompting for user interaction during the processing through alerts, assigning requirements to a different confirmation strategy and restarting the BOP run, performing another BOP run with alternate requirements, or over-confirming the material-plant combination and creating a user alert prompting a user to resolve the combination.

FIG. 4B is a process flow diagram 470 displaying the relationship inheritance of each requirement 410. Win requirement 420 can gain quantity from either redistribute requirement 440, fill requirement 450, or lose requirement 460. A special case exists in that win requirement 420 cannot gain from gain requirement 430. Gain requirement 430 can gain quantity from redistribute requirement 440, fill requirement 450, or lose requirement 460. Redistribute requirement 440 can gain quantity from itself, fill requirement 450, or loser requirement 460. Fill requirement 450 can gain quantity from lose requirement 460 up to a previously confirmed quantity. Fill requirement 450 can also gain quantity from itself up to a previously confirmed quantity. Lose requirement 460 loses all confirmed quantity irrespective of it being used by any other requirement.

Redistribute requirement 440 can either gain or lose quantity. A fill requirement 450 provides a delete confirmation, if required, and either (i) does not gain quantity and keeps the confirmation or (ii) loses quantity. A lose requirement 460 loses the entire confirmed quantity.

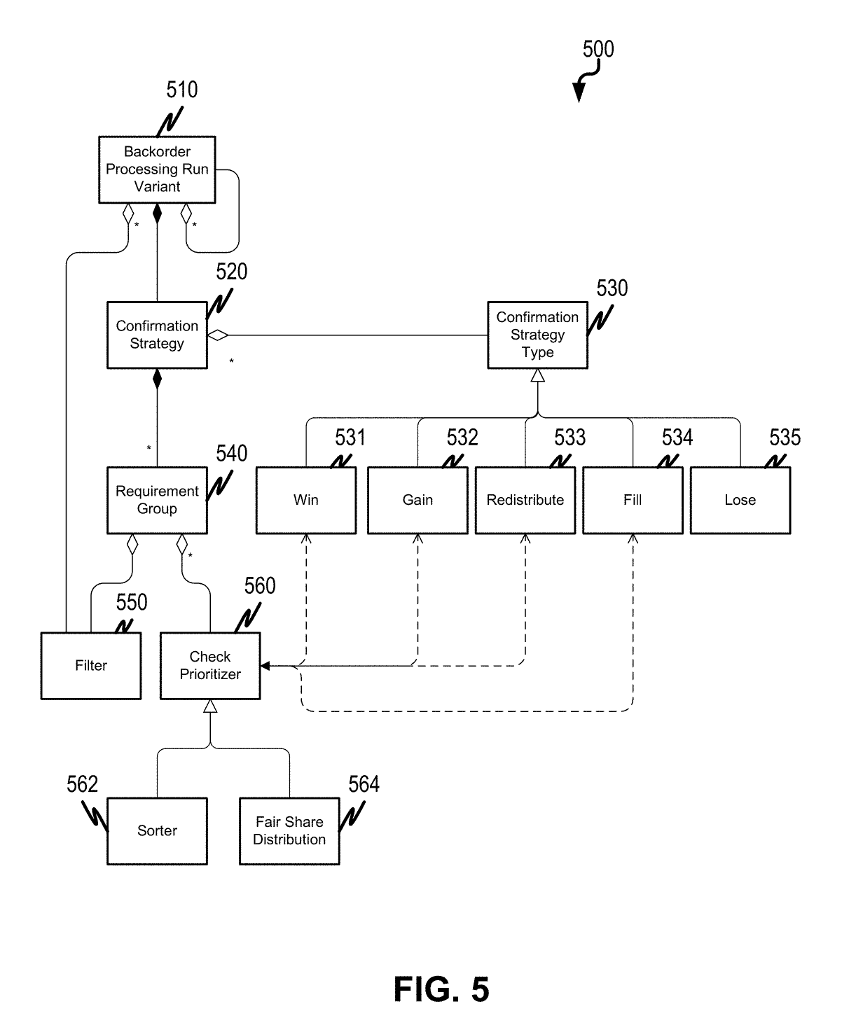

FIG. 5 is an example process interaction diagram 500 illustrating interaction between a BOP run variant 510, confirmation strategies 520, and filters 550. Each requirement 410 belongs to a requirement group 540. Each requirement 410 is processed with different confirmation strategy types 530 that include a win strategy 531, a gain strategy 532, a redistribute strategy 533, a fill strategy 534, or a lose strategy 535. For example, win strategy 531 includes a win requirement 420, a gain strategy 532 includes a gain requirement 430, etc. Each requirement group has a check prioritizer and an assigned confirmation strategy type. The priority can be checked by a check prioritizer function 560 which can be a sorter 562 or a fair-share distribution 564. For example, each requirement can get 10% of the requested quantity or distribute the available quantity evenly and independently of the requested quantity.

Each requirement 410 is determined by a filter 550. Filters 550 can be of several filter types. A requirement 410 can pass through several filters 550 simultaneously. Filters 550 can be, for example, exceptional filters, upgrade filters, or downgrade filters. A requirement 410 can be upgraded, for example, from a redistribute requirement 440 to a gain requirement 430 by assigning a filter 550 to the gain strategy and leaving the rest of the BOP run variant 510 unmodified. Since the gain requirement 430 has a higher priority than the redistribute requirement 440, the requirements are assigned to the gain strategy 532.

Filters 550 can also be assigned a priority by being marked either as an exceptional filter or a downgrade filter. Requirements 410 can be downgraded, for example, using a downgrade filter. A downgrade filter can be assigned to a lose strategy 535 which has a higher priority than a downgrade filter assigned to a fill strategy 534. The priority of downgrade filters is inverted compared to the priority order of each requirement 410. In order to downgrade a gain requirement 430 to a redistribute requirement 440, for example, a filter 550 can be marked as a downgrade filter and assigned to redistribute requirement 440.

Alternatively, a filter execution priority can be established for a filter 550. The filter execution priority can be assigned in several ways. In one alternative, the requirement group 540 sequence can define the filter execution priority. The filter execution priority can be related to filter types including item filters, characteristic filters, or remainder filters. Alternatively, the filter execution priority can be assigned to the filter entity. In another alternative, the filter execution priority can be assigned to the requirement group.

Filter 550 can also be an optional global filter of the BOP run variant 510. The optional global filter can be applied with other filters of the run variant at runtime that can include geographical or time-horizon related criteria. The optional global filter assists in defining disjoint variants that can be executed in parallel.

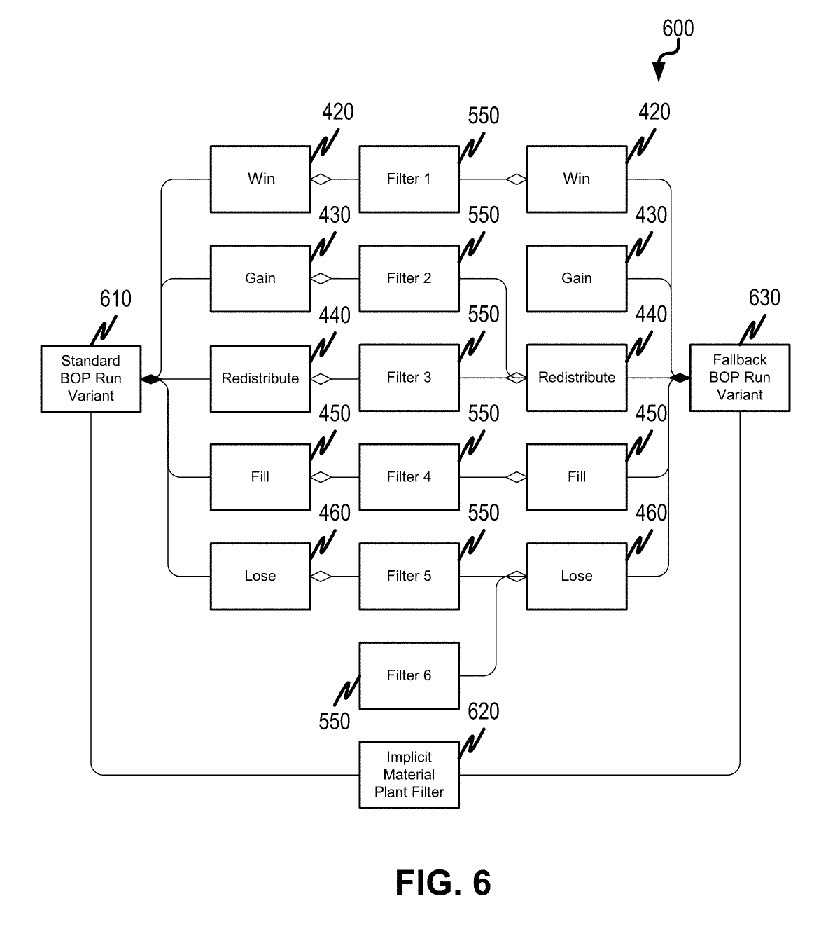

FIG. 6 is an example process flow diagram 600 of a failed BOP run. A standard BOP run variant 610 can fail, for example, when either a win requirement 420 or a gain requirement 430 fail. Standard BOP run variant 610 can be executed as described herein applying various requirements including win requirement 420, gain requirement 430, redistribute requirement 440, fill requirement 450, and/or lose requirement 460.

Upon failure of the standard BOP run variant 610, a fallback BOP run variant 630 can resolve the failures in a variety of ways. For example, filters 550 can be downgraded for either the win requirement 420 or gain requirement 430 (i.e., Filter 2 is downgraded to redistribute requirement 440). In another example, another filter 550 can be applied to lose requirement 460 (i.e., Filter 6). In yet another example, additional rules can be added to a rules-based availability (RBA) check. An RBA check can provide a confirmation which differs from the original requirement, either by confirming a different material (e.g. a gold-plated socket instead of a standard socket) or out of a different location.

If, during execution of standard BOP run variant 610, either win requirement 420 or gain requirement 430 fail during execution, a couple process variations are possible. In one example, the requirements of the material-plant combination are not updated. A fallback BOP run variant 630 can be started with an additional implicit material-plant filter 620 for the material-plant combination. A BOP variant records a problem with one or more material-plant combinations. Rather than re-processing all requirements from the original BOP run, an implicit material plant filter 620 can be set on the problematic material-plant combination, thereby ensuring that only the problematic material-plant combinations are re-processed with different priorities or on the basis of different documents (e.g. additional documents whose confirmed quantities are taken).

In another example, execution of the standard BOP run variant 610 can be immediately stopped. This can occur, for example, when a RBA check is used as the material-plant combinations are correlated via substitution rules. In this example, a fallback BOP run variant 630 can be started automatically without implicit material-plant filter 620.

In some cases, some material-plant combinations are explicitly excluded by filters 550, in which case some of implicit material-plant filter 620 are not processed. For example, there may be a special material-plant combination that requires manual processing in the event of a failure. If requirements of implicit material-plant filter 620 are not processed in the fallback BOP run variant 630, then these unprocessed requirements are written to a log.

There is no indication, however, that a BOP variant is a fallback BOP variant 630. A run variant has a role of a fallback BOP run variant 630 if it is referenced as a fallback BOP run variant in another variant. A chain of variants can be built via a referencing mechanism. For example, a fallback BOP run variant for a fallback BOP run variant. A cycle check can be required for a chain of variants. A fallback BOP run variant 630 is executed similar to the standard BOP run variant 610, with each variant having a different requirement combination.

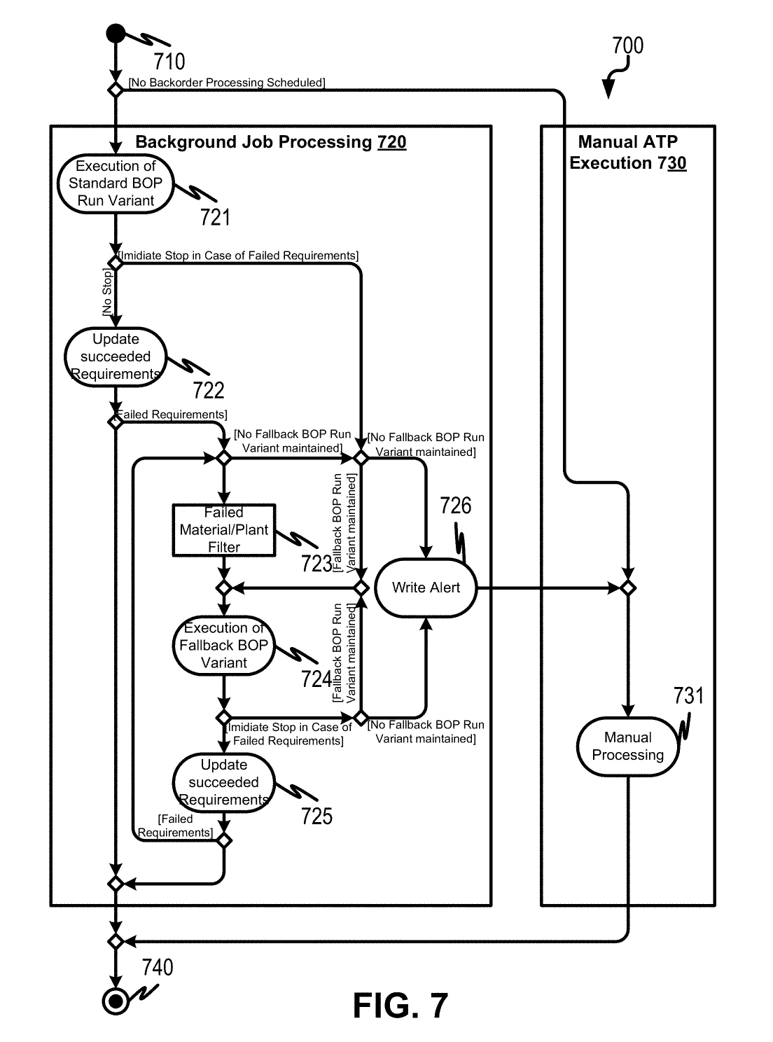

FIG. 7 is an example process flow diagram 700 of backorder processing. The BOP initiates at 710. BOP can be performed using either background job processing 720 or manual ATP execution 730. Manual ATP execution 730 can occur, for example, when there is no backorder processing scheduled. During manual ATP execution 730, manual processing, at 731, is performed by a user to fulfill the backorders for the material-plant combination. After the manual processing, at 731, the backorder processing ends, at 740.

When backorder processing is scheduled, a standard BOP run variant 610 is executed, at 721, and each requirement 410 is filtered. Should either a win requirement 420 or gain requirement 430 cause the background job processing 720 to be stopped, then the presence of a fallback BOP run variant 630 is evaluated. If a fallback BOP variant 630 is maintained, then the failed material-plant combination is passed through a failed material-plant filter, at 723. The fallback BOP variant 630 is then executed, at 724. A failure of either a win requirement 420 or a gain requirement 430 prompts an user alert to be written, at 726, which identifies the failure to a user. The user can then resolve the failure through manual processing, at 731. If a requirement 410 of a material-plant combination fails, then the requirement 410 of the material-plant combination is not updated. Alternatively, if the fallback BOP variant 630 provides no failures, then the succeeded requirements are updated, at 725. The backorder job processing 720 ends at 740.

If during execution of the standard BOP run variant 610, the requirements 410 are successful, then the succeeded requirements are updated, at 722, and the backorder job processing ends, at 740.

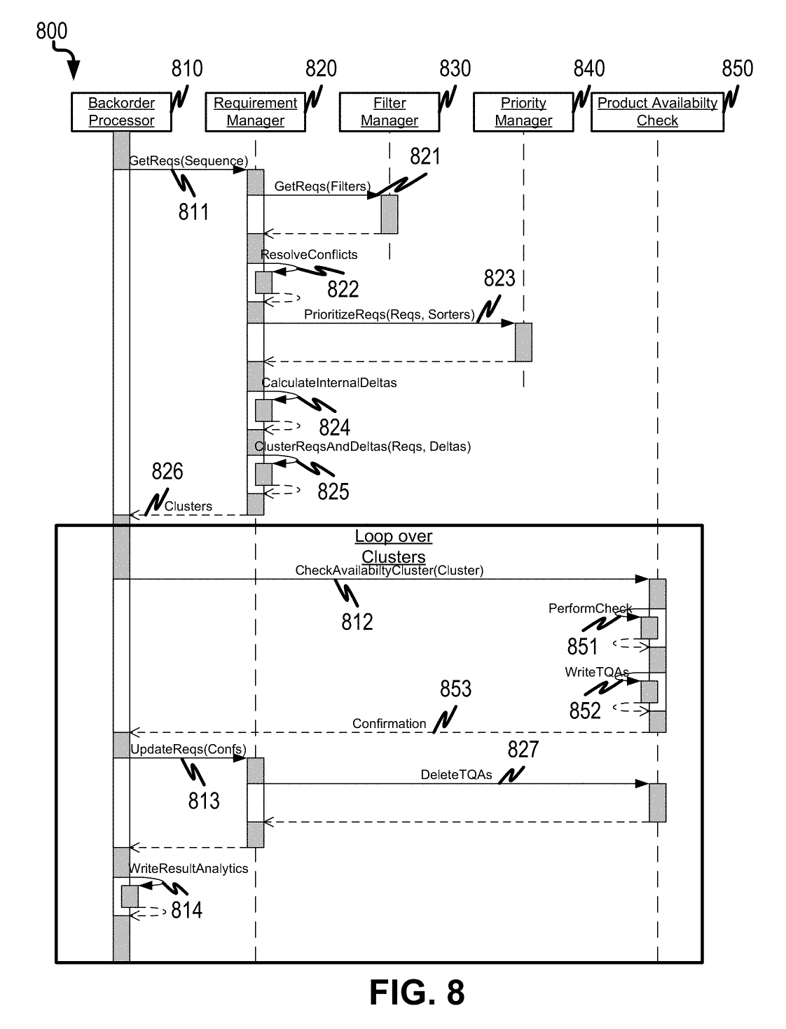

FIG. 8 is a data flow diagram 800 of backorder processing. One or more backorder processors 810 provide a request, at 811, to requirement manager 820, to obtain a sequence of requirements 410. The requirements manager 820 provides a request, at 821, to obtain filters 550 from a filter manager 830. Conflicts amongst the requirements 410 are resolved, at 822, by the requirements manager 820. A conflict can exist, for example, if a requirement 410 is selected by two filters assigned to two different confirmation strategies (e.g. win and redistribute). In this case, the requirement manager 820 identifies that the requirement has to be removed from the redistributor requirement group, since it is already in the win requirement group. Each requirement 410 occurs once for a given BOP run.

The requirements manager 820 provides a request, at 823, to a priority manager 840 to prioritize and sort requirements 410 using sorter 562 and fair share distributor 564. Internal deltas are calculated, at 824, by requirements manager 820. The requirements 420 and internal deltas are clustered together, at 825. Requirements are clustered by material-plant combination if ATP checks are being used. If RBA is used, substitutable material-plant combinations in the substitution chain have to be clustered. The clusters are provided, at 826, by the requirements manager 820 to backorder processor 810.

The clusters can be iterated over to evaluate backorder availability of the material-plant combination. Backorder processor 810 provides a request, at 812, to product availability check 850 to check the availability of the material-plant combination of the clusters. The product availability check 850 performs the availability check, at 851, and writes out temporary quantity assignments (TQAs), at 852. Product availability check 850 then provides a confirmation, at 853, to backorder processor 810. Backorder processor 810 provides a request, at 813, to requirements manager 820 to update requirements 410 based on the confirmation. Requirements manager 820 provides a request, at 827, to product availability check 850 to delete the TQAs. Backorder processor 810 then, at 814, writes result analytics. These result analytics can be provided to a user. For example, a portion of the result analytics can be displayed, loaded into memory, stored, or transmitted to a remote computing system.

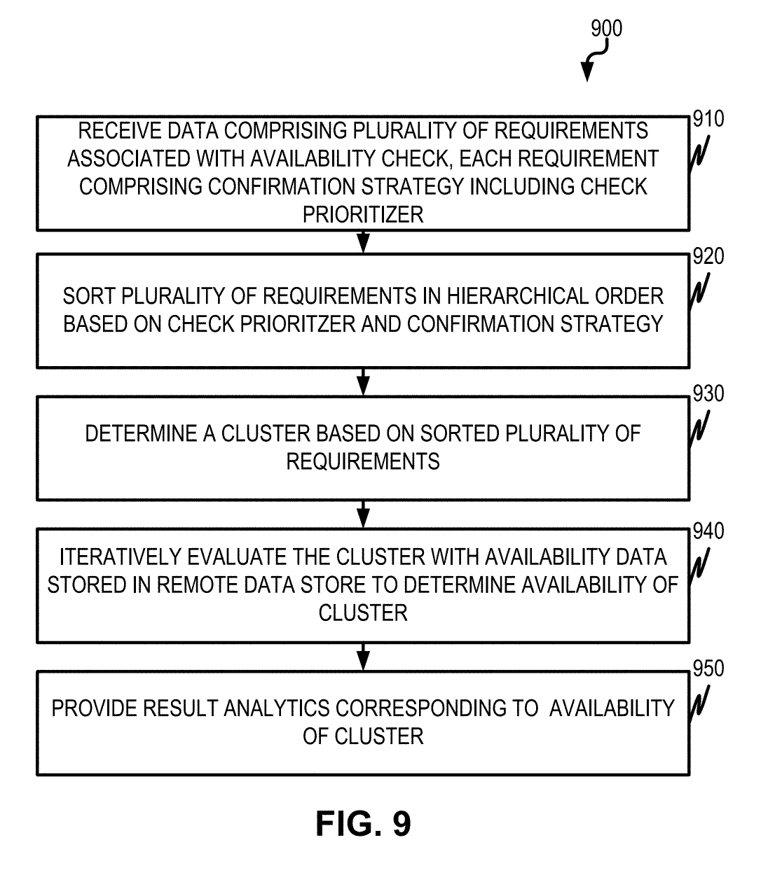

FIG. 9 is an example process flow diagram 900 for single job backorder processing using prioritized requirements. Data comprising a plurality of requirements associated with an availability check are received, at 910. Each requirement comprises a confirmation strategy including a check prioritizer. The plurality of requirements are determined by applying at least one filter to the requirements in a system. A requirement is a request for a certain material, for a given date and/or time in a specified quantity, possibly in a certain plant, for example, a schedule line in a sales order. A filter selects specific requirements based on business criteria, which could comprise geographic criteria or time-horizon criteria, or any other business criteria such as sales organizations, customers, etc. Each requirement is given a certain priority which leads to a sorted sequence for assigning confirmations to it.

The plurality of requirements is sorted, at 920, in a hierarchical order based on the check prioritizer and the confirmation strategy. Clusters including plurality of requirements are determined, at 930, based on confirmation strategy by check prioritizer. The clusters are iteratively evaluated, at 940, comparing the cluster with availability data stored in a remote data store to determine availability of the cluster. Result analytics corresponding to the availability of the cluster are provided, at 950.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random access memory associated with one or more physical processor cores.

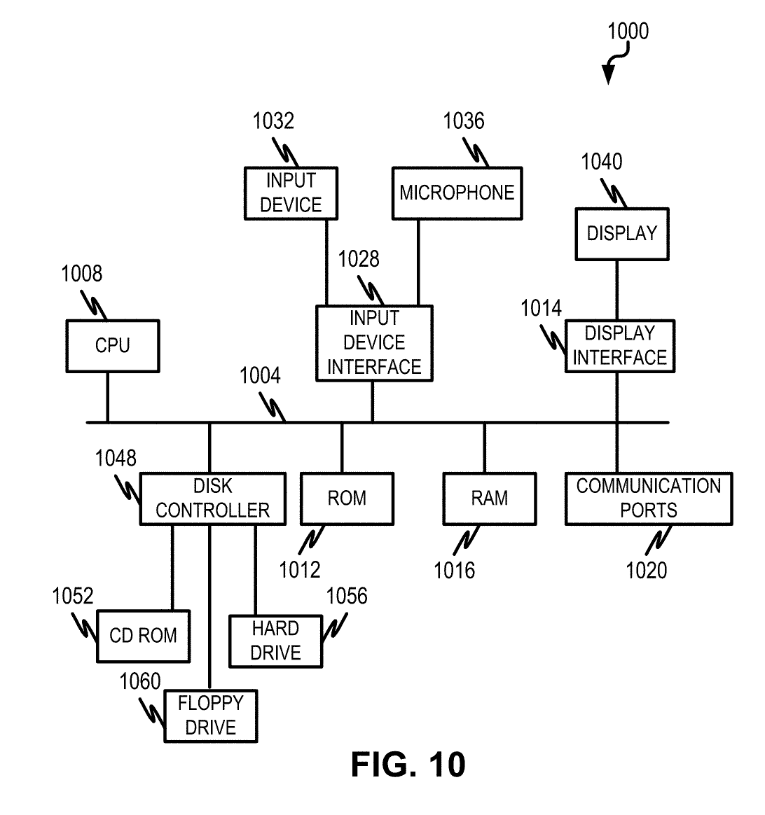

FIG. 10 is a diagram 1000 illustrating a sample computing device architecture for implementing various aspects described herein. A bus 1004 can serve as the information highway interconnecting the other illustrated components of the hardware. A processing system 1008 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1012 and random access memory (RAM) 1016, can be in communication with the processing system 1008 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1048 can interface one or more optional disk drives to the system bus 1004. These disk drives can be external or internal floppy disk drives such as 1060, external or internal CD-ROM, CD-R, CD-RW or DVD, or solid state drives such as 1052, or external or internal hard drives 1056. As indicated previously, these various disk drives 1052, 1056, 1060 and disk controllers are optional devices. The system bus 1004 can also include at least one communication port 1020 to allow for communication with external devices either physically connected to the computing system or available externally through a wired or wireless network. In some cases, the communication port 1020 includes or otherwise comprises a network interface.

To provide for interaction with a user, the subject matter described herein can be implemented on a computing device having a display device 1040 (e.g., a CRT (cathode ray tube) or LCD (liquid crystal display) monitor) for displaying information obtained from the bus 1004 to the user and an input device 1032 such as keyboard and/or a pointing device (e.g., a mouse or a trackball) and/or a touchscreen by which the user can provide input to the computer. Other kinds of input devices 1032 can be used to provide for interaction with a user as well; for example, feedback provided to the user can be any form of sensory feedback (e.g., visual feedback, auditory feedback by way of a microphone 1036, or tactile feedback); and input from the user can be received in any form, including acoustic, speech, or tactile input. In the input device 1032 and the microphone 1036 can be coupled to and convey information via the bus 1004 by way of an input device interface 1028. Other computing devices, such as dedicated servers, can omit one or more of the display 1040 and display interface 1014, the input device 1032, the microphone 1036, and input device interface 1028.

To provide for interaction with a user, the subject matter described herein can be implemented on a computer having a display device (e.g., a CRT (cathode ray tube) or LCD (liquid crystal display) monitor) for displaying information to the user and a keyboard and a pointing device (e.g., a mouse or a trackball) and/or a touchscreen by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for a single job backorder processing using prioritized requirements implemented by one or more data processors forming one or more computing devices, the method comprising:
receiving, by at least one data processor of a computing device, data comprising a plurality of requirements associated with an availability check, each requirement comprising a confirmation strategy including a check prioritizer;
sorting, by at least one data processor, the plurality of requirements in a hierarchical order based on the check prioritizer and the confirmation strategy;
determining, by the at least one data processor, a cluster based on the sorted plurality of requirements;
iteratively evaluating, by at least one data processor, the cluster with availability data stored in a remote data store to determine availability of the cluster; and
providing, by at least one data processor, result analytics corresponding to the availability of the cluster.

2. The method according to claim 1, wherein the iteratively evaluating further comprises:
determining, by at least one data processor, a success or a failure of the plurality of requirements; and
resolving the failure of the at least one requirement by at least one of modifying the check prioritizer of the at least one requirement, excluding the at least one requirement, adding new requirements to the plurality of requirements, modifying geographical aspects of the at least one requirement, modifying time-dependent aspects of the at least one requirement, and initiating display of the failure in a user alert on a graphical user interface.

3. The method according to claim 1, wherein the single job backorder is an Available-to-Promise (ATP) check and the determining comprises a cluster based on material-plant combinations.

4. The method according to claim 1, wherein the single job backorder is a Rule-Based Availability (RBA) check and the determining comprises a cluster based on substitutable material-plant combinations.

5. The method according to claim 1, wherein the plurality of requirements include at least one of a win requirement, a gain requirement, a redistribute requirement, a fill requirement, or a lose requirement.

6. The method according to claim 5, wherein the hierarchical order of the check prioritizer from a highest check prioritizer to a lowest check prioritizer is the win requirement, the gain requirement, the redistribute requirement, and the fill requirement.

7. The method according to claim 1, wherein the receiving, sorting, determining, iteratively evaluating, and providing are executed in an in-memory database.

8. The method according to claim 1, wherein the availability data comprises at least one of an available quantity and an available date.

9. A non-transitory computer-programmable product having storing instructions which, when executed by at least one data processor, result in operations comprising:
receiving, by at least one data processor of a computing device, data comprising a plurality of requirements associated with an availability check, each requirement comprising a confirmation strategy including a check prioritizer;
sorting, by at least one data processor, the plurality of requirements in a hierarchical order based on the check prioritizer and the confirmation strategy;
determining, by at least one data processor, a cluster based on the sorted plurality of requirements;
iteratively evaluating, by at least one data processor, the cluster with availability data stored in a remote data store to determine availability of the cluster; and
providing, by at least one data processor, result analytics corresponding to the availability of the cluster.

10. The non-transitory computer-programmable product according to claim 9, wherein the iteratively evaluating further comprises:
determining, by at least one data processor, a success or a failure of the plurality of requirements; and
resolving the failure of the at least one requirement by at least one of modifying the check prioritizer of the at least one requirement, excluding the at least one requirement, adding new requirements to the plurality of requirements, modifying geographical aspects of the at least one requirement, modifying time-dependent aspects of the at least one requirement, and initiating display of the failure in a user alert on a graphical user interface.

11. The non-transitory computer-programmable product according to claim 9, wherein the single job backorder is an Available-to-Promise (ATP) check and the determining comprises a cluster based on material-plant combinations.

12. The non-transitory computer-programmable product according to claim 9, wherein the single job backorder is a Rule-Based Availability (RBA) check and the determining comprises a cluster based on substitutable material-plant combinations.

13. The non-transitory computer-programmable product according to claim 9, wherein the plurality of requirements include at least one of a win requirement, a gain requirement, a redistribute requirement, a fill requirement, or a lose requirement.

14. The non-transitory computer-programmable product according to claim 9, wherein the hierarchical order of the check prioritizer from a highest check prioritizer to a lowest check prioritizer is the win requirement, the gain requirement, the redistribute requirement, and the fill requirement.

15. The non-transitory computer-programmable product according to claim 9, wherein the receiving, sorting, determining, iteratively evaluating, and providing are executed in an in-memory database.

16. The non-transitory computer-programmable product according to claim 9, wherein the availability data comprises at least one of an available quantity and an available date.

17. A system for a single job backorder processing using prioritized requirements, the system comprising:
at least one data processor;
memory storing instructions which, when executed by the at least one data processor, result in operations comprising:
receiving, by at least one data processor of a computing device, data comprising a plurality of requirements associated with an availability check, each requirement comprising a confirmation strategy including a check prioritizer;
sorting, by at least one data processor, the plurality of requirements in a hierarchical order based on the check prioritizer and the confirmation strategy;
determining, by at least one data processor, a cluster based on the sorted plurality of requirements;
iteratively evaluating, by at least one data processor, the cluster with availability data stored in a remote data store to determine availability of the cluster; and
providing, by at least one data processor, result analytics corresponding to the availability of the cluster.

18. The system according to claim 17, wherein the iteratively evaluating further comprises:
determining, by at least one data processor, a success or a failure of the plurality of requirements; and
resolving the failure of the at least one requirement by at least one of modifying the check prioritizer of the at least one requirement, excluding the at least one requirement, adding new requirements to the plurality of requirements, modifying geographical aspects of the at least one requirement, modifying time-dependent aspects of the at least one requirement, and initiating display of the failure in a user alert on a graphical user interface.

19. The system according to claim 17, wherein the receiving, sorting, determining, iteratively evaluating, and providing are executed in an in-memory database.

20. The system according to claim 17, further comprising an in-memory database.
